(19) United States
(12) Patent Application Publication
(10) Pub. No.: US 2005/0176420 A1
(43) Pub. Date: Aug. 11, 2005

(54) Wireless network detector

(76) Inventors: James Graves, St. Charles, IL (US); Debra Jones, Schaumburg, IL (US); Benjamin D. Kern, Chicago, IL (US); Boon Meksavan, St. Charles, IL (US); Joe Shidle, Hoffman Estates, IL (US)

Correspondence Address: MCDERMOTT, WILL & EMERY LLP, 227 WEST MONROE STREET, CHICAGO, IL, 60606-5096, US

(21) Appl. No.: 10/897,239

(22) Filed: Jul. 22, 2004

Related U.S. Application Data
(60) Provisional application No. 60/542,007, filed on Feb. 5, 2004.

(51) Int. Cl. H04Q 7/20; H04B 7/212

(52) U.S. Cl. 455/424; 455/423

(57) ABSTRACT

There is provided a wireless network detector that easily and conveniently enables a user to scan and find access points for one or more wireless network present in a scanned location. The detector can provide visual and audio feedback about the detected wireless networks. The wireless network detector can provide information to a user, including, the strength of a signal, network identifying information such as network SSID, whether encryption is enabled, etc. The wireless network detector can translate technical network SSIDs or labels into descriptive and understandable text, symbols or names that can be displayed to the user. In one aspect, the wireless network detector scans for transmissions of IEEE 802.11 wireless access points to obtain configuration characteristics relating to a detected wireless fidelity network. The wireless network detector can be configured to detect selected wireless networks and to display detection results only for selected or related wireless networks.

### CROSS-REFERENCE TO RELATED APPLICATIONS

The present application claims the benefit of U.S. provisional patent application No. 60/542,007, filed on Feb. 5, 2004 and titled “Wireless Network Detector”.

### TECHNICAL FIELD

The present subject matter relates to wireless computing and wireless networking. More specifically, the present subject matter relates to a wireless network detector designed to search for wireless access points and provide information regarding the configuration of one or more wireless networks present and available in a scanned location.

### BACKGROUND

A wireless network or wireless local area network (WLAN) is an increasingly common alternative or supplement to a wired local area network (LAN). Wireless networks can be installed and used in enterprises, homes, and public computing environments. A wireless network enables a user to have mobility for a computer or device connected to the wireless network in a certain defined area or location, such as a building, store, business, office, home or public or private areas. Computers and devices on a wireless network, such as laptop computers and personal digital assistants (PDAs), can access information and data on the wireless network or on the Internet without being physically connected to the network. A typical WLAN is includes interconnected computers and associated components that can communicate with each other through radio-frequency (RF) transmission or broadcast signals to exchange and transfer data. The broadcasting and receiving of data using RF signals permits and enables portability and mobility of computers and other devices connected to a wireless network.

A variety of wireless networking technologies are commonly available, including Bluetooth, infrared data association (IrDA), Home radio frequency (HomeRF), and “Wireless Fidelity” or “Wi-Fi”, among others. Protocols for communication, data transfer and interoperability between devices on a wireless network are typically governed by industry standards. For a wireless fidelity or Wi-Fi type wireless network, IEEE 802.11a, IEEE 802.11b, IEEE 802.11g and IEEE 802.11i are some specifications, standards and protocols that have been by adopted and promulgated by the Institute of Electrical and Electronics Engineers (IEEE). IEEE is a well-known and authoritative organization in the area of networking and wireless technologies. These standards or specifications are specifically incorporated herein by reference.

A typical wireless network has one or more fixed-position wireless transceivers or network access points that broadcasts radio frequency signals over a geographic area. The access points can also receive signals and data transmitted by and from other devices. Access points typically have an integrated Ethernet controller to connect to an existing wired-Ethernet network or local area network (LAN) so that users can make wireless connections to back-end system server farms, to Internet or Intranet connections, and/or to access other wired network services such as e-mail applications, and document or file access applications.

A wireless fidelity network typically operates using spread-spectrum modulation of radio waves in the frequency range of 2.4 gigahertz (GHz) or 5 GHz at various data speeds up to about 54 megabits (MB) per second. The wireless network can have a broadcast range of about one thousand (1,000) feet in open areas, and about two hundred (200) to four hundred (400) feet in a closed or obstructed area. Access points broadcast certain information in order to indicate the presence and availability of a wireless network or Wi-Fi network in a geographic area, as well as to indicate other information useful or necessary in connecting to the network.

The wireless network can be a public wireless network available to the general public, or may be a private or commercial wireless network that permits authorized access on a subscription or fee basis. In addition, wireless networks that offer users or consumers free or affordable high-speed wireless access to the Internet have become very popular and are prevalent in many locations with large amounts of consumer traffic. Wireless networks providing access and connections to the Internet can be used as a means to attract consumers to an establishment and to increase attendance, visibility and sales of commercial or consumer products and services. Some mobile phone providers or wireless Internet service providers also offer Wi-Fi networks on a pay-for-use or subscription basis. The presence and availability of an access point for a wireless network Internet connection is commonly referred to as a “hotspot”.

In order for a user to connect to a wireless network, the user must find a network access point or “hotspot”. Connection to a network access point or “hotspot” is typically done through a computing device, such as a laptop computer, a handheld personal digital assistant (PDA) or other device that has a wireless access card or that otherwise contains an integrated wireless functionality. A device equipped with a wireless access card or chipset can scan for and locate a network access point. If the device is properly configured, it may be able to make a radio or radio frequency link to the wireless network and bi-directionally communicate and transmit data.

In order for users to find wireless network access points or hotspots, a user must typically have prior knowledge of locations with wireless network access points. Once a user is at a location that has access points for wireless network access, a user will typically turn on or boot-up a wireless-enabled device, for example a portable laptop computer. Once the device has booted-up, the user activates or initiates a dedicated wireless software application that scans for and locates a wireless network's access point broadcast signal. Once located, the user can connect to the wireless network, which may, in some cases, require an authentication and authorization log-in procedure. This is often a time consuming process since it requires that the user turn on and boot-up the computing device in order to search for and connect to the wireless network. This process can be especially inconvenient for a user that boots-up the laptop computer or PDA, only to realize or find out that a wireless network is not present, or that the network is closed to the user.

Further, the wireless connection process requires that the user have existing or previous knowledge of the location of wireless network connections or hotspots that are accessible to users or the public. If the user does not have such knowledge, the user needs to call ahead to a location or check available listings for “hotspots”, e.g., using the Internet on a hard wired network. Alternatively, a user can simply go to a location that he/she believes may have wireless network access points and boot-up their wireless compatible device in the hopes that a wireless network is present. These approaches for locating a wireless network are time consuming, inefficient and inconvenient for a user with limited time.

Network providers of a wireless network often choose to identify their network by selecting a Service Set Identifier (“SSID”) containing the operator's name, or otherwise containing terms describing and identifying the network. The network provider's SSID is broadcast as part of the RF signal in a beacon frame. The SSID may help a user determine whether a network is intended for public or private use, or whether the user has a subscription that would allow the user to access a particular network. Furthermore, wireless networks can be encrypted to provide security for network users and to restrict access by unauthorized users. Currently, users typically determine this information by using scanning software on a Wi-Fi enabled device, such as a computer or PDA.

Finally, a network operator may have agreements with other operators that permit roaming between networks with different SSIDs. A network operator may have difficulty disseminating information to its subscriber users that other wireless networks with different SSIDs may be accessed by the users which subscribe to the network operator's service. A device that can convert or translate SSIDs into easily recognizable descriptive words or names could help a network operator inform its users of the extent, coverage and availability of the operator's network. A device that could be customized to recognize one or more selected SSIDs could also be of great value to a network operator in encouraging users to use only its associated network access points.

There is thus a need for a wireless network detecting device or apparatus that conveniently and easily enables a user to search for wireless network access points, to gauge relative signal strength in different locations, to determine configuration information about whether the network is intended to for commercial or public use, and to determine whether encryption is enabled on a detected network. There is additionally a need for a device that can translate or convert network identifying information into easily recognized names or words, or that can selectively recognize wireless networks corresponding or identified by specific SSIDs.

### SUMMARY

There is provided a wireless network detector or device that easily and conveniently enables a user to search for and find access points for a wireless network or local area network (WLAN), and that is adapted to provide visual and/or audio feedback about the presence of a wireless network access point or “hot spot”. The wireless network detector can provide information about detected wireless networks to users, including, but not limited to, the strength of a signal, identifying information regarding a network, and whether encryption has been enabled on the wireless network. The wireless network detector can also be configured to provide information useful to technical users, and to translate technical network SSIDs or labels into descriptive and understandable text, symbols or names, and display information relating to selected networks. In one example, the wireless network detector specifically searches for transmissions of IEEE 802.11b/g wireless access points to obtain information and configuration characteristics about or relating to a detected wireless fidelity (Wi-Fi) network.

There is provided a portable network detector for detecting a wireless network having a signal and data processing means adapted to scan for and demodulate radio frequency (RF) signals originating from a wireless network access point in a wireless fidelity network. The wireless fidelity network includes access points that generates RF signals that correspond to an IEEE 802.11 radio frequency transmission and have a frequency of about 2.4 GHz or 5.0 GHz. The signal and data processing means executes instructions for detecting and identifying a wireless network and for generating corresponding output results. The output results include configuration characteristics of a detected wireless network such as a service set identifier, encryption status, signal strength or a channel number. The detector includes a user interface means for enabling user operation of the detector and for visually and audibly presenting the output results to a user, and a power source adapted to provide regulated operating power for the network detector. The portable network detector may be a handheld and/or an integrated apparatus.

In another example, there is provided an integrated portable network detector for scanning and detecting a wireless network having an antenna for receiving radio frequency (RF) signals, a wireless chipset for demodulating the received RF signals, a central logic unit comprising a processor for executing computer executable instructions for detecting and identifying a wireless network signal and for generating corresponding output results, a display for visual presentation of the output results to a user, a device operation push button for actuating operation of the network detector, and a power source adapted to provide operating power for the network detector. The network detector can also include an audio enable switch for permitting audible feedback of the output results, an audio component adapted to provide the audible feedback of the output results when the audio enable switch is set to an enable position, and a system voltage regulator coupled to the power source for providing a uniform operating power level to the network detector. The network detector can detect RF signals that originate from a wireless network access point that is part of a wireless fidelity network.

Additionally, there is provided a portable and integrated network detector for detecting a wireless network that includes computer-executable instructions for performing the steps of scanning for radio frequency (RF) signals associated with a wireless network access point, receiving and demodulating the RF signals, converting the demodulated RF signals to a digital formatted data packet, parsing the data packet to determine whether a beacon frame from an access point is present. If no beacon frame is present, a negative indication is outputted to a user. If a beacon frame is present, configuring information about the access point and corresponding wireless network and displaying or outputting to the user. The network detector may also measure signal strength of the RF signal corresponding to the present beacon frame, and output the extracted configuration information to the user. The outputted configuration information can be customized to provide specific messaging upon detection of one or more selected or predetermined wireless networks. In one aspect, the RF signals originate from a wireless network access point in a wireless fidelity network which includes access points that generate RF signals corresponding to an IEEE 802.11 standard.

It is an objective to provide a wireless network detector that can scan for, detect and provide feedback to a user about whether a wireless network is present and/or available in a scanning location.

It is an objective to provide a wireless network detector that can detect a wireless network in a scanning location and provide feedback to the user about whether the detected wireless network is encrypted and whether it is an open or closed network, as well as information that may allow a user to determine whether the network is public or private, and free or subscription based.

It is further an objective to provide a wireless network detector that can display the SSID or identifying information about a network, and can convert this identifying information into a form that can be understood more easily by a user.

It is an objective to provide a wireless network detector that can be customized on behalf of network operators to display, or not display, detected network information or to display specific messaging depending on the detected network's SSID in order to promote the network operator's network, or to facilitate use of the network operator's network.

It is an objective to provide a wireless network detector that is portable, compact and lightweight such that it can be carried in, among other places, a user's hand or pocket.

It is also an objective to provide a wireless network detector with low power requirements that is economical and affordable.

It is another objective to provide a wireless network detector that can display the signal strength of an access point signal as an indicator of data quality available from the wireless network via the access point and to allow a user to select an optimal location from which to connect to the network.

It is another objective to provide a wireless network detector that can display whether encryption or other security is enabled on a wireless network for purposes of allowing a user to determine whether a network can be used.

It is another objective to provide an inexpensive, handheld wireless network detector that can display whether encryption or other security is enabled on a wireless network and the accessibility of the network for purposes of allowing a business enterprise or network operator to assess, troubleshoot and plan the security of its network.

It is another objective to provide a wireless network detector that can provide technical information, including signal-to-noise ratio, wireless channel congestion indicators, and hardware addresses or identifying information.

It is still another objective to provide a wireless network detector that can gauge relative signal strength in different locations.

It is yet another objective to provide a wireless network detector that can provide information that may allow a user to determine whether a network is intended to be for commercial or public use.

It is another objective to provide a low-cost handheld wireless network detector that can provide channel information that may allow a user to assess the likelihood of network interference, to troubleshoot interference issues, and plan a network configuration that will minimize interference.

It is further an objective to provide a handheld wireless network detector that can provide information about multiple wireless networks, whether operating on the same RF channel or on different channels.

Additional objects, benefits, advantages and novel features of the subject matter will be set forth in part in the description which follows, and in part will become apparent to those of ordinary skill in the art upon examination of the following and the accompanying drawings or may be learned by practice, production or operation of the subject matter. The objects and advantages of the concepts and subject matter may be realized and attained by means of the methodologies, instrumentalities and combinations particularly pointed out in the appended claims.

### BRIEF DESCRIPTION OF THE DRAWINGS

The drawings and figures depict one or more implementations in accord with the present concepts and subject matter, by way of example only, not by way of limitation. In the figures, like reference numerals refer to the same or similar elements. The description may be better understood when read in connection with the accompanying drawings, of which:

FIG. 1 illustrates a system block diagram for a wireless network detector according to one aspect of the present subject matter;

FIG. 2 illustrates an embodiment of the wireless network detector of FIG. 1 according to one aspect of the present subject matter; and

FIG. 3 illustrates a process flow operation of the wireless network detector of FIG. 1 according to one aspect of the present subject matter.

### DETAILED DESCRIPTION

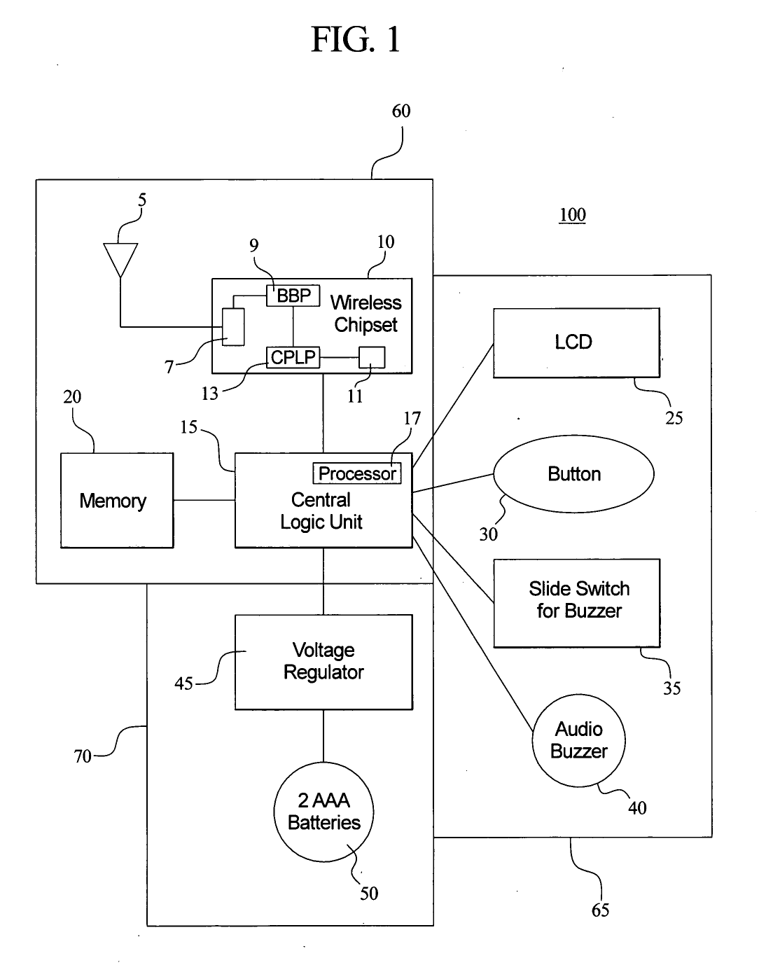

FIG. 1 shows a system block diagram for a wireless network detector 100 according to one aspect of the present subject matter. The wireless network detector 100 is preferably a compact and portable electronic and/or computerized device that enables a user to easily, quickly and conveniently search for and find access points for a wireless network or local area network (WLAN). The wireless network detector 100 can provide visual and audio feedback about the presence of a wireless network in a geographic or physical location by scanning for and detecting the presence of signal transmission of IEEE 802.11 wireless access points or “hot spots”.

The wireless network detector 100 can additionally provide visual, and optionally audible, output or feedback about a detected wireless network. The wireless network detector can scan for, detect and provide feedback to a user about whether a wireless network is present and/or available in a scanning location. The wireless network detector also provides feedback to the user about whether the detected wireless network is encrypted and whether it is an open or closed network, as well as information that may allow a user to determine whether the network is public or private, and free or subscription-based. The wireless network detector can display SSID or identifying information about a network, and can convert this identifying information into a form that can be understood quickly and easily by a user. The wireless network detector can also provide the signal strength of a wireless network signal, identify network information, identify whether encryption is enabled in the detected network, and indicate the channel on which each detected network is operating.

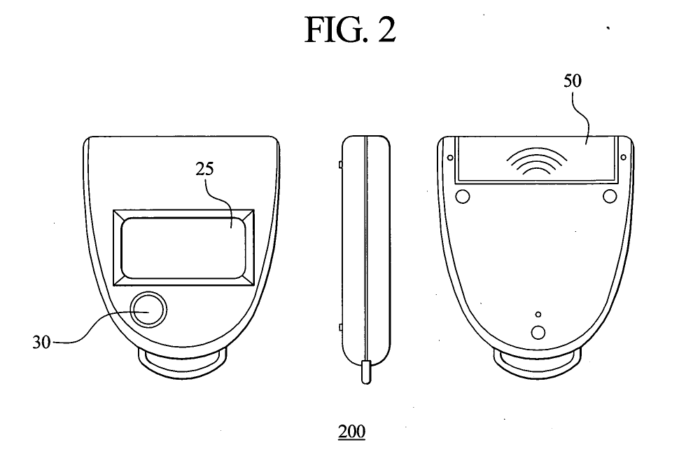

The wireless network detector 100, shown in the example in FIG. 1, includes an antenna 5, a wireless chipset 10, a central logic unit 15, associated storage memory 20, a liquid crystal display (LCD) 25, a device operation push button 30, an audio enable switch 35, an audio component 40, a system voltage regulator 45, and a power source 50. Preferably, all of the various components are contained in a single integrated housing 200, as shown in the example of FIG. 2.

The wireless network detector 100 also includes operating and control software or programming code that is executable by a processor 17 in the central logic unit 15. The central logic unit 15, through execution of the operating and control software, controls the operation of the wireless chipset 10 and other elements or components of the wireless network detector 100, including the associated memory 20, the LCD 25, the device operation button 30, the audio enable switch 35, the audio component 40, and the system voltage regulator 45.

The components of the wireless network detector 100 can be configured as three subsystems: a data processing subsystem 60, a user interface 65 and a power source subsystem 70. In one case, the data processing subsystem 60 includes the antenna 5, the wireless chipset 10, e.g., an IEEE 802.11a or IEEE 802.11b/g chipset, the processor or central logic unit 15 and the associated storage memory 20. The user interface 65 includes the LCD 25, the device operation push button 30, the audio enable switch 35, e.g., a slide switch, and the audio component or buzzer 40. The power source subsystem 70 can include the system voltage regulator 45 and the power source 50, e.g., direct current (DC) batteries such as one or two AA or AAA batteries.

The antenna 5 and wireless chipset 10 detect radio frequency signals, e.g., IEEE 802.11a, 802.11b, 802.11g signals, and demodulate them. The antenna 5 and chipset 10 can scan eleven (11) channels in search of an IEEE 802.11 access point. The antenna 5 is preferably an internal receiving antenna and receives radio frequency (RF) signals transmitted over the air by an RF source, such a wireless network access point. The antenna 5 and wireless chipset 10 can receive and detect signals transmitted using various radio frequency transmission technologies. Examples of such technologies include direct-sequence spread spectrum (DSSS) and/or frequency-hopping spread spectrum (FHSS). Also, the antenna 5 and wireless chipset can detect spread-spectrum radio waves, and other radio waves, in the frequency range of about 2.4 gigahertz (GHz) to 2.462 GHz and/or 5 GHz at various data speeds up to about 54 megabits (MB) per second.

The antenna 5 preferably has a detection range of about two hundred (200) feet and a receiving sensitivity of about −80 dBm. Those of ordinary skill in the art will readily recognize that the detection range and receiving sensitivity may be adjusted to fit particular applications or uses of the wireless network detector 100. The antenna detection range may be larger or smaller, and may vary depending on environmental conditions and the physical make-up of the location or structure, i.e., building, home, etc., where the signal scanning and detection is carried out. Those of ordinary skill in the art will readily recognize that the receiving antenna 5 can be a directional antenna, an omni-directional antenna or other known type of antennas, including a passive or active antenna, and/or a one-dimensional or two-dimensional antenna, etc. Further, in some applications, the antenna 5 may instead be part of a transceiver capable of both receiving and transmitting radio frequency signals.

The antenna 5 is connected to a radio or wireless local area network (WLAN) radio 7, in the wireless chipset 10, that is tuned to receive selected radio frequency signals. When scanning for a Wi-Fi network, the radio 7 in the wireless chipset 10 can be tuned to detect 802.11 radio frequencies, e.g., IEEE 802.11 b/g signals. The tuned radio frequency signals can include radio waves in the frequency range of about 2.4 gigahertz (GHz) or 5 GHz.

The wireless chipset 10 can be can be configured to demodulate radio frequency signals that have been modulated using one or more modulation schemes, such as phase-shift keying (PSK), differential quadrature phase-shift keying (DQPSK), differential bi-phase-shift keying (DBPSK), frequency-shift keying (FSK) or complimentary code keying (CCK) technology. In some cases, the CCK modulation technology is preferred since it permits higher data speed or rate of about 5.5 Mega bits per second (MBps) to about 11 MBps and is typically less susceptible to multipath-propagation interference. Those of ordinary skill in the art will readily recognize that the detector 100 can be configured to demodulate radio frequency signals having other modulation schemes. The tuned radio frequency signals are demodulated by the radio 7 and wireless chipset 10 into electrical signals for processing by the central logic unit 15.

As shown in FIG. 1, the wireless chipset 10 includes the WLAN radio 7, a baseband processor (BBP) 9, and a complex programmable logic device (CPLD) 13. The radio 7 can be tuned to receive particular or desired radio frequencies transmitted over the air by one or more radio frequency sources, such as wireless network access points, and receives the radio frequency transmission through the antenna 5. The radio 7 converts these radio frequency signals into electrical signals for processing by the baseband processor 9. The baseband processor (BBP) 9 analyzes the electrical signals from the radio 7, and determines whether a specific type of data is being transmitted, for example, data from an access point. The baseband processor 9 converts the electrical signals from an analog format to a digital format, and formats the received data stream to conform to predetermined requirements of the wireless network detector 100. The baseband processor 9 then transmits the formatted data stream as a serial data stream to the complex programmable logic device (CPLD) 13 for further processing.

The CPLD 13 can be made up of a single programmable chip. By providing the CPLD 13 in a single chip 13, the physical size of the CPLD 13 which in turn will lead to lower power requirements to operate the CPLD 13. The CPLD 13 is programmed to receive the 802.11 packet data from the baseband processor 9 as a serial data stream, and transforms the received serial data stream into digital bytes which are then transmitted to the central logic unit 15. In one aspect, the CPLD 13 provides a small buffer 11 for the temporary storage of the bytes. Stored bytes are later transmitted to the central logic unit 15 four (4) bytes at a time. In this manner, the microprocessor 17 in the central logic unit 15 can receive and read four (4) bytes at a time instead of frequently reading one byte at a time received from the BBP 9. The wireless chipset 10, through the BBP 9 and the CPLD 13, after demodulating and converting the received radio frequency signals into electrical signals, transmits the digital signals, four (4) bytes at a time to the central logic unit 15 for further processing.

The central logic unit 15 processes and parses the digital data stream received from the wireless chipset 10 and extracts configuration information about a detected access point. The central logic unit 15, via its processor 17, processes the received data stream and extracts selected information about a detected wireless network from the beacon frames. As is known to those of skill in the art, an access point periodically transmits a beacon frame to announce its presence and relay information, such as a timestamp, SSID, encryption indication and other parameters regarding the access point and its associated wireless network. The central logic unit 15 can also determine whether the detected wireless network is encrypted or open, can provide information such as an SSID, that may allow a user to determine whether the network is public or private and free or subscription-based network, and is able to differentiate between RF signals from a wireless network, such as WiFi or 802.11 signals, and other wireless signals such as those generated by cordless phones, microwave ovens, etc. The central logic unit 15 can store the processed configuration information in memory 20 and can subsequently display it via the LCD 25.

The central logic unit 15 carries out various functions and capabilities through the execution of operating and control software or program code by a microprocessor, processor, micro-controller or controller 17. The operating and control software or programming code can be stored in the central logic unit 15 or in accessible memory storage 20. In one example, the software or programming code is written in C programming language, although other known programming languages may be used as well. In one aspect of the wireless network detector 100, the software is not upgradeable or modifiable. However those of ordinary skill in the art will readily recognize that the wireless network detector 100 may also have upgradeable and modifiable software or programming code.

The operating and control software is configurable such that the central logic unit 15 can receive demodulated or decoded frames from the wireless chipset 10, parse the received frames and display them to the user via the LCD 25. The operating and control software parses valid beacon frames, extracts the SSID and encryption status from the beacon frames, and determines the signal strength of valid channels detected, among other functions. The central logic unit 15 can display, via the LCD 25, the SSID, channel number, encryption indication and signal strength for each valid beacon frame received, along with other programmed functions.

The operating and control software enables the central logic unit 15 to control and operate the various components of the wireless network detector 100. The operating and control software enables the central logic unit 15 to control user interface controls. The operating and control software permits the central logic unit 15 to operate the LCD 25 to display, among other displayed information, configuration information about detected access points or “hot spots” to the user of the detector 100. The operating and control software permits the central logic unit 15 to operate the audio component 40 and appropriately respond to actuation of the device operation button 30 and the audio enable switch 35. The operating and control software monitors the power levels of the power source 50 and generates low battery indications or alarms when the power source 50 voltage drops to or below a predetermined alarm thresh hold level.

The operating and control software can set the wireless network detector 100 in a power save, standby or sleep mode after a first predetermined period of inactivity. For example, the wireless network detector 100 can be set in a power save mode if there is no user activity or interaction with the detector for the first predetermined time period, e.g., one (1) minute. Further, the operating and control software can be configured to automatically turn the detector 100 off after a second predetermined period, e.g., three minutes, of inactivity or since the last user actuation of a component on the detector 100.

As shown in FIG. 1, and as noted previously, the user interface 65 of the wireless network detector 100 includes various associated components, including: the LCD 25, the device operation button 30, the audio enable switch 35, the audio component 40. The LCD 25 visually presents information to the user by serving as the means to display, among other displayed information, configuration information about detected access points or “hot spots”, including, SSID, signal strength, encryption indication, etc. In one case, the LCD 25 is a monochrome display having one (1) line×twelve (12) characters LCD running at 3.3 Volts DC and a dimension of about 40 mm×14 mm. Those of skill in the art will readily recognize that the LCD 15 may have a different configuration. For example, the display may be a color display with a larger display screen.

The device operation push button 30 enables a user to turn on the wireless network detector 100 and initiate scanning and detection of a wireless network. The device operation push button 30 can also be pushed or actuated additional times to cycle between multiple detected access points or “hot spots” and to rescan for new access points.

The audio enable switch 35 can be actuated to permit the user to enable or disable the audio component or buzzer 40. In one case, the audio enable switch 35 can be a slide switch that can be toggled between enable and disable positions. The audio enable switch 35 may also have other configurations that permit a user to enable or disable the audio component or buzzer 40. For example, the audio enable switch 35 could instead be another push button that can be pressed repeatedly to cycle between the enable or disable positions.

Upon the command of the central logic unit 15, the audio component or buzzer 40, when activated or enabled by the audio enable switch 35, can audibly alert the user when a wireless network has been found. For example, an audible sound, such as a chirp sound, may be generated when an IEEE 802.11a, or IEEE 802.11b/g network is detected. Those of ordinary skill in the art will readily recognized that the audio component 40 could also be activated by the central logic unit 15 for other conditions where audible output may be beneficial and useful. For example, the audio component 40 may be generated to alert the user of a low battery status, and to signal that the failure of components in the wireless network detector 100, etc. A typical piezoelectric buzzer may be used as the audio component 40. Since the piezoelectric buzzer typically requires approximately 135 milliwatts (mW) to operate, the audio component 40 may be disabled from time to time to minimize power consumption.

The power source subsystem 70 includes the system voltage regulator 45 and power source 50. The system voltage regulator 45 operates to maintain a steady system power supply voltage which is set at a predetermined voltage level, e.g., at 3.0 Volts DC or 3.3 VDC. The system voltage regulator 45 may operate independently to maintain the desired voltage level or may cooperate with the central logic unit 15 to maintain the voltage level at a desired or predetermined voltage level. The desired or predetermined voltage level can vary according to a specific application or need. The system voltage regulator 45 may also include circuitry and electrical components to detect a low battery condition and to alert when such a condition is reached.

The wireless network detector 100 is preferably powered by a convenient and accessible power source 50. In one example, the wireless network detector 100 is powered by two (2) AAA batteries which can power the device for up to two (2) month with a typical or standard operating usage, which may include on average two (2) wireless network scans per day with the audio function disabled where the detector 100 requires approximately 160 mW in receive mode. Those of skill in the art will recognize that other power sources, electrical or otherwise, may instead be used in some cases, including an AC power source, a solar power source, etc.

FIG. 2 illustrates one example of a wireless network detector 200 contained within an integral housing to provide an integrated, compact and portable device. The detector 200 can be carried in a user's hand, key chain, clothing pocket or other convenient location or means or attached to an item such as a key chain. The wireless network detector's 200 size and portability make it a very convenient device to use and carry from place to place to rapidly and easily search for access points or “hot spots”. In one example, the wireless network detector 200 has physical or mechanical dimensions of about 50 mm (Length)×60 mm (Width)×15 mm (Height) and a weight of about 70 grams. Those of skill in the art will readily recognize that the wireless network detector 200 can be an integrated device having other dimension or can be a device having multiple and separate components.

Generally, a user can interact with and operate the wireless network detector 100 to interactively submit input commands and to thereby receive feedback about wireless network access point signal transmissions from one or more detected wireless networks in a physical or geographical area. The wireless network detector 100 scans and searches for signal transmissions from wireless network access points and provides a visual feedback and, if enabled, audio feedback about the presence and detection of a wireless network. Those of ordinary skill in the art will readily recognize that the operating and control software can be configured to search for any of a variety of transmission signals, including, an IEEE 802.11a/b/g/i wireless network or a wireless fidelity (Wi-Fi) network, among others.

The wireless network detector 100, through execution of the operating and control software, scans for beacon frames transmitted by wireless network access points on each of a plurality of channels used for IEEE 802.11 networking. The wireless network detector 100 optimally scans in a detection range of about two hundred (200) feet, though other detection ranges, larger or smaller, are also possible depending on the power and capacity of the components used in the detector 100. The detector scans for about set scan period, e.g., five (5) seconds or other chosen scan time period. For each channel on which beacon frames are received, via the antenna 5, the wireless chipset 10 will detect and demodulate the IEEE 802.11 signals.

The central logic unit 15, through execution of the operating and control software, will process and parse the received data. The micro-controller or processor 17 of the central logic unit 15 receives the demodulated 802.11 packet data from the CPLD 13 and executes a WiFi detector software application residing on in the wireless network detector 100. The WiFi detector application can reside in the central logic unit memory 11 or in associated local memory 20 and is accessible to the processor 17. As a data packet is being received, the operating and control software examines the data to determine whether there is a beacon frame from an access point. If beacon frames are received on one or more channels, the operating and control software extracts selected configuration information about a detected wireless network and stores the information. The central logic unit 15, through, its operating and control software, can also determine whether the detected wireless network is encrypted or open, and can provide information that may allow a user to determine whether the network is public or private, and free or subscription-based. Further, the central logic unit 15 can differentiate between RF signals from a wireless network, such as WiFi or 802.11 signal, and other wireless signals such as those generated by cordless phones, microwave ovens, etc.

After scanning for access point signal transmissions from, e.g., Wi-Fi channels, is completed, the stored scanning results can be selectively displayed or outputted to the user. Configuration information about the detected wireless network or networks is displayed or outputted to the user via the LCD 25 and, if enabled, the audio component 40. If multiple wireless networks are detected, the user can view and cycle through configuration information relating to the detected wireless network 100 by pressing the device operation button 30.

The wireless network detector 100 can indicate or display output data for each detected network such as a service set identifier (SSID), network identification name, received signal strength, encryption enabled indication, channel number (1-11), etc., among other information describing and identifying a detected network. Further, the wireless network detector may display the SSID and channel number as simple text. If enabled, the detector 100 can also audibly indicate that a Wi-Fi network or hotspot is present and has been detected.

The signal strength can be displayed as a horizontal bar graph on the LCD 25. In one aspect, the signal strength display can represent an indication of the data quality that is available from the access point of the detected wireless network 100. The detector 100 can use display bars, e.g., up to four display bars, to indicate signal strength and data quality. One bar can correspond to low signal strength and poor data quality while four bars can correspond to high signal strength and good data quality. Those of ordinary skill in the art will readily recognize that other known means can be used to indicate the signal strength, instead of or in addition to the LCD bars. For example, the detector 100 and 200 could use one or more light emitting diodes (LEDs) to represent the signal strength and available data rate. Also, an icon can be displayed on the LCD 25 to indicate whether encryption is enabled on a detected wireless network.

The detector 100 can provide a low battery indicator via the LCD 25 to inform the user that the power source 50, e.g., the batteries, need to be replaced. The low battery indicator may be displayed as a text message or an icon. The low battery indicator can be displayed when the detector 100 is activated or turned on or, if already on, when the power source 50 falls to or below a predetermined low voltage alert level. In addition, the detector 100 may audibly signal a low battery condition through the audio component 40, i.e., audio buzzer, when the audio enable switch 35 is enabled.

If no beacon frames are received after scanning, a negative indication can be outputted to the user, via the LCD 25 and, if enabled, the audio component 40. The user can then, if desired, rescan all channels by again pressing the device operation button 30. During each wireless network detector scan, new wireless networks may be detected and information for previously detected networks can be updated.

In one aspect of operation, when the wireless network detector 100 is turned on, the operating and control software will initialize the various detector components and hardware on power-up or boot-up. Initially, the processor 17 and central logic unit 15 are set up or initiated. Next, the radio 7, BBP 9, and the CPLD 13 in the wireless chipset 10 are set up. The LCD is then configured and a welcome message can be displayed to the user. The radio 7, BBP 9, and CPLD 13 of the wireless chipset 10 are then enabled.

Once these tasks are completed, the operating and control software begins scanning through selected radio frequency signals or transmissions. For example, selected wireless network channels, such as 802.11a/b/g/i channels. The operating and control software controls and tunes the radio 7 to a specific channel or set of channels, and waits to see if the BBP 9 and CPLD 13, of the wireless chipset 10, transmit any valid 802.11 data packets to the processor 17. Those of ordinary skill in the art will readily recognize that the operating and control software can be selectively configured to scan for one or more specific or selected channels and frequencies. In one preferred aspect of the present subject matter, the wireless network detector 100, through its operating and control software, is set to scan for wireless network or WiFi access points or “hot spots”.

When the beginning of a data packet is detected by the processor 17, the operating and control software reads the data into the processor's memory 11 or detector memory 20. After the first seventy (70) bytes are read-in, the operating and control software checks designated fields of the 802.11 data packet that can indicate whether a beacon frame is from a wireless network access point.

The operating and control software: a) analyzes the packet type to determine whether a beacon frame is a specific type of 802.11 management frame; b) the destination medium access control (MAC) address, which for a wireless network beacon frame can be the standard broadcast address “0×FFFFFFFFFFFF”; c) confirms that the extended service set identifier (ESSID) or the network identifier is identical to the source MAC address; d) confirms that the SSID or network name has a length which is between zero (0) and thirty-two (32) bytes; and d) confirms that the SSID consists of text characters. The SSID is a unique network identifier which has a length that is at a fixed position inside the beacon frame. The SSID is also referred to as a network name because it is essentially a name that identifies a wireless network. The SSID itself is located right after the length and can be zero (0) to thirty-two (32) characters long. The SSID differentiates one WLAN from another, so access points and devices attempting to connect to a particular WLAN must use the same SSID. After a beacon frame has been received and verified, the SSID itself is checked to see that the length matches the actual text, where the text consists of printable characters.

If the operating and control software determines that all these conditions are true, then the beacon frame with this data packet is determined to be a valid beacon frame. The operating and control software also determines whether the detected wireless network is encrypted or open, and can provide information that may allow a user to determine whether the network is public or private or is free or subscription-based, and differentiates between RF signals from a wireless network, such as WiFi or 802.11 signal, and other wireless signals such as those generated by cordless phones, microwave ovens, etc. The operating and control software then measures the signal strength from the radio 7.

The operating and control software compares the extended service set identifier (ESSID) to that of other recently received beacon frames. If the ESSID matches, then this corresponding access point (AP) has been previously detected and displayed, and preferably will not be displayed again during this scanning pass. This features reduces duplication and optimizes the detection of new access points. In an alternate aspect, the detector 100 can be configured to display the access point each time it is detected.

If the detected ESSID is a newly encountered ESSID, the operating and control software halts the scanning, and the radio 7, BBP 9, and CPLD 13 are transitioned into a low-power, inactive mode. The operating and control software then displays the SSID or network name, channel number, signal strength, and encryption status on the LCD 25. If these characters, text and information are longer than the LCD display 25, the operating and control software will begin to scroll the information from right to left after a short delay. Those of skill in the art will readily recognize that other means and methods of displaying the information may be used as well, including displaying information individually in a cycling manner. For example, the SSID or network name, channel number, signal strength, and encryption status may each be displayed individually one at a time for a finite time period, e.g., three (3) seconds.

In one aspect of operating the wireless network detector 100, the detector 100 and its operating and control software can be configured to prioritize selected or preferred SSIDs and/or to filter detected wireless networks based on their SSID. The detector 100 and its operating and control software can be configured or customized to provide specific messaging or outputting upon detection of a wireless network, or to display such results only upon detection of one or more wireless networks pre-selected or designated by a manufacturer of a particular network detector, or by or on behalf of an operator of a particular wireless network or networks

This aspect and feature can be used to configure the wireless network detector 100, typical on behalf of a network operator, to provide prominence and priority to selected or specifically identified networks. For example, if a first service provider XYZ uses the SSID “XYZ” on all access points it operates, and a second service provider ABC uses the SSID “ABC” on all the access points it operates. The wireless network detector 100 can be configured to selectively display only information relating to the access points of the first service provider which have an “XYZ” SSID. When configured in this manner, the wireless network detector 100 would not display information relating to access points having an “ABC” SSID or any other non-“XYZ” SSID. Those of ordinary skill in the art will readily recognize that the wireless network detector 100 can and does detect other networks, however, the operating and control software has been configured to only display information relating to the selected access points. In this case, access points having an “XYZ” SSID.

Additionally, the wireless network detector 100 and the operating and control software can be configured differently in cases where the first service provider XYZ has a business relationship with the second service provider ABC that allows customers of the first service provider XYZ to use the second service provider ABC's network. In this aspect, the operating and control software and detector 100 can be configured to display the term “XYZ Network” or other predetermined label selected by the first and/or second service providers. In this aspect, the detector 100, through its operating and control software, will display the “XYZ Network” or other agreed upon label when a wireless network SSID is detected that corresponds to either a wireless network bearing an “XYZ” SSID or an “ABC” SSID. In one preferred aspect, this feature is referred to as “SSID translation”, however, other terms may instead be used.

If the user does not press or actuate any components on the wireless network detector for a predetermined period of time, the operating and control software will power-off the detector 100. In one case for example, after about thirty (30) seconds of displaying network information, such as SSID, signal level, encryption indication, channel status, etc., the detector 100 software powers-off the detector 100 after thirty (30) seconds of user inactivity. Alternatively, the operating and control software place the detector 100 in a standby or sleep mode after the pre-define time period of inactivity.

If the device operation button 30 is pressed, within the predetermined time period, scanning for valid access point signals and transmission begins again. The detector scanning will continue until another beacon frame is found. After the operating and control software has finished scanning through the designated channels, e.g., channels 1-11 for 802.11b, the ESSID cache is cleared so that previously detected access point scan be displayed again in a subsequent scan.

If no access point is detected after a fixed number of passes, e.g., three passes, through all available channels, the operating and control software displays a message indicating that no access point was found and powers off. In some configurations, the operating and control software may time out after a certain pre-define time period and place the detector in a stand-by mode or again power-off the detector 100.

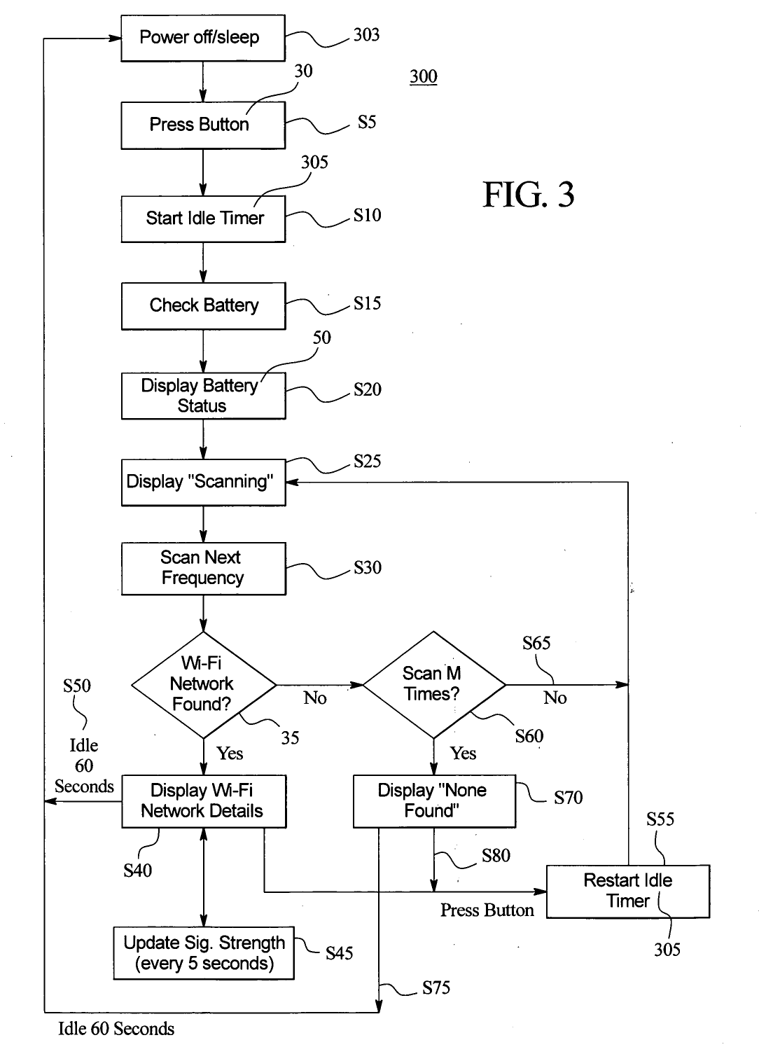

FIG. 3 illustrates a process flow diagram 300 for using the wireless network detector 100 to detect a wireless network access point or “hot spot” according to one aspect of the present subject matter. In one aspect, the detector specifically searches from a wireless fidelity or Wi-Fi type wireless network such as IEEE 802.11a, IEEE 802.11b, IEEE 802.11g and IEEE 802.11i. One or more software applications and/or software code may be written and created, for execution in the central logic unit 15, to detect wireless network access points and display the scanning result to a user.

In step S5, a user initiates wireless network scanning on the wireless network detector 100 by actuating or pressing the device operation button 30. This will turn the detector 100 ON from either an off state or from a standby/sleep mode.

In step S10, the operating and control software will initiate an internal counter or timing circuit 305 that will transition the detector 100 to an OFF state or a standby or sleep mode after a predetermined time of inactivity, e.g., sixty (60) seconds, by the user.

In step S15, the operating and control software checks the energy lever or status of the power source 50, i.e., the batteries used by the detector 100. In Step S20, the operating and control software can display the results of the power source check on the LCD 25.

In step S25, the operating and control software initiates radio scanning for access point transmissions and can display the label “Scanning” on the LCD 25 to inform the user that scanning is in process.

In step S30, once a particular channel or frequency has been detected, the detector operating and control software will continue to scan a next selected radio frequency signal or transmission. For example, the detector may scan up to eleven (11) channels when scanning for wireless network such as 802.11a/b/g/i channels, or may scan more channels when configured for use outside the United States.

In step S35, a determination is made whether a Wi-Fi Network has been found, which, as discussed previously, is based on whether a radio frequency signal compliant with IEEE 802.11 has been received and detected.

In step S40, if a WiFi network is found, the operating and control software will cause the LCD 25 to display network configuration information and details relating to the detected WiFi networks. The displayed information can include: service set identifier (SSID), network identification name, received signal strength, encryption enabled indication, channel number (1-11), etc., among other information describing and identifying the detected wireless network.

In step S45, the wireless network detector periodically updates and displays the signal strength to the user. This can provide the user with an indication of the detected signal strength and the data quality available from the detected access point. In one case, the operating and control software can be configured to update the signal strength periodically, e.g., every five (5) seconds.

In step S50, if after displaying WiFi network details, the user does not interact with the detector 100 for a time period that equals or exceeds a predetermined time of inactivity, e.g., sixty (60) seconds, the operating and control software will transition the detector 100 to an off state or standby/sleep mode from the on state. At this point, the process can again begin at step S5.

In step S55, if after displaying WiFi network details, the user interacts with the detector 100 prior to the predetermined time of inactivity, e.g., by pressing the operation button 30, the internal counter or timing circuit 305 will be reset and the internal counter or timing circuit 305 will begin anew monitoring the time of user inactivity. The operating and control software can then transition the detector 100 back to step S25, for scanning of access point transmissions and displaying the “Scanning” label.

In step S60, if a WiFi network is not found, the operating and control software determines whether the detector 100 has scanned for access point transmissions for a predetermined number of time, e.g., an “M” number of times. This determination prevents the detector 100 from endlessly scanning for access point transmissions, thereby avoiding endless scanning loops or unnecessarily draining the power source 50. The scan number “M” can have a value chosen by the user or may be pre-set by the manufacturer of the detector 100.

In step S65, if the detector has not scanned “M” times, the operating and control software transitions the detector 100 back to step S25, for continued scanning of access point transmissions and display of the “Scanning” label.

In step S70, if the detector has scanned “M” times, the operating and control software cause the LCD 25 to a display label informing the user that no WiFi access points were detected, e.g., the display 25 may read “None Found”.

In step S70, if after displaying an indication that no WiFi access points were found, the user does not interact with the detector 100 for a time period that equals or exceeds the predetermined time of inactivity, i.e., sixty (60) seconds, the operating and control software will transition the detector 100 to the OFF state or standby/sleep mode. At this point, the process can again begin at step S5.

In step S80, if after displaying an indication that no WiFi access points were found, the user interacts with the detector 100 prior to the predetermined time of inactivity, e.g., by pressing the operation button 30, the internal counter or timing circuit 305 will be reset and the internal counter or timing circuit 305 will begin anew monitoring the time of user inactivity. The operating and control software can then transition the detector 100 back to step S25, for scanning of access point transmissions and displaying the “Scanning” label.

While the foregoing has described what are considered to be the best mode and/or other examples, it is understood that various modifications may be made therein and that the technology and subject matter disclosed herein may be implemented in various forms and examples, and that they may be applied in numerous other applications, combinations and environments, only some of which have been described herein. Those of ordinary skill in the art will recognize that the disclosed aspects may be altered or amended without departing from the true spirit and scope of the subject matter. Therefore, the subject matter is not limited to the specific details, representative devices, exhibits and illustrated examples in this description. It is intended by the following claims to claim any and all modifications and variations that fall within the true scope of the advantageous concepts and claims disclosed herein.

1. A portable network detector for detecting a wireless network comprising:
a signal and data processing means adapted to scan for and demodulate radio frequency (RF) signals, and for detecting and identifying one or more wireless networks and for generating corresponding output results;
a user interface means coupled to said signal and data processing means for receiving user input, and enabling user operation of said network detector, and for presenting said output results to a user; and
a power source adapted to provide operating power for said signal and data processing means and said user interface means.

2. The network detector of claim 1, wherein said output results comprise configuration characteristics of a detected wireless network.

3. The network detector of claim 2, wherein said configuration characteristics comprise at least one of a service set identifier, encryption status, signal strength and a channel number.

4. The network detector of claim 1, wherein said output results correspond to one or more wireless networks designated by said user.

5. The network detector of claim 1, wherein said output results correspond to one or more wireless networks designated by a manufacturer of said network detector.

6. The network detector of claim 1, wherein said RF signals originate from a wireless network access point.

7. The network detector of claim 6, wherein said wireless network access point is part of a wireless fidelity network.

8. The network detector of claim 6, wherein said RF signals correspond to an IEEE 802.11 radio frequency transmission.

9. The network detector of claim 1, wherein said network detector detects wireless network RF transmission signals having a frequency of about 2.4 GHz or 5.0 GHz.

10. The network detector of claim 1, further comprising;
an audio enable component for permitting audible output results; and
an audio component device adapted to provide said audible output results.

11. The network detector of claim 1, further comprising:
a system voltage regulator cooperatively coupled to said power source for providing a uniform operating power level for said network detector.

12. The network detector of claim 11, further comprising:
a device operation push button adapted to actuate operation of said network detector.

13. The network detector of claim 1, wherein said output results are visually presented via a liquid crystal display.

14. The network detector of claim 13, wherein said output results are presented as text or symbols.

15. The network detector of claim 1, wherein said network detector has a detection range of about two hundred feet.

16. The network detector of claim 1, wherein said network detector is a handheld or integrated apparatus.

17. The network detector of claim 1, wherein said power source is selected from the group consisting of an electrical power source, a chemical power source, a solar power source and a fuel cell power source.

18. The network detector of claim 1, wherein said power source is selected from the group consisting of a direct current power source and an alternating current power source.

19. An integrated portable network detector for scanning and detecting a wireless network comprising:
an antenna for receiving radio frequency (RF) signals;
a wireless chipset for demodulating said received RF signals;
a central logic unit comprising a processor for executing computer executable instructions for detecting and identifying a wireless network signal and for generating corresponding output results;
a display for visual presentation of said output results to a user;
an actuating device for controlling operation of said network detector; and
a power source adapted to provide operating power for said network detector.

20. The network detector of claim 19, further comprising:
an audio enable switch for permitting audible output results; and
an audio component adapted to provide said audible output results.

21. The network detector of claim 20, further comprising:
a system voltage regulator coupled to said power source for providing a uniform operating power level to said network detector.

22. The network detector of claim 19, wherein said output results comprise configuration characteristics of a detected wireless network.

23. The network detector of claim 22, wherein said configuration characteristics comprise at least a service set identifier, encryption status, signal strength or a channel number.

24. The network detector of claim 19, wherein said output results correspond to one or more wireless networks designated by said user.

25. The network detector of claim 19, wherein said output results correspond to one or more wireless networks designated by a manufacturer of said network detector.

26. The network detector of claim 19, wherein said RF signals originate from a wireless network access point.

27. The network detector of claim 26, wherein said wireless network access point is part of a wireless fidelity network.

28. The network detector of claim 26, wherein said RF signals correspond to an IEEE 802.11 radio frequency transmission.

29. The network detector of claim 19, wherein said network detector detects wireless network RF transmission signals having a frequency of about 2.4 GHz or 5.0 GHz.
